(19) United States
(12) Patent Application Publication
(10) Pub. No.: US 2016/0346810 A1
(43) Pub. Date: Dec. 1, 2016

(54) ROBOT CAPABLE OF VIBRATING BASED ON PRESSURE

(71) Applicant: HON HAI PRECISION INDUSTRY CO., LTD., New Taipei (TW)

(72) Inventors: CHIA-HUNG LIAO, New Taipei (TW); Ga-Lane Chen, Santa Clara, CA (US); Chau-Yuan Ke, New Taipei (TW)

(21) Appl. No.: 14/820,088

(22) Filed: Aug. 6, 2015

(30) Foreign Application Priority Data
May 27, 2015 (CN) 201510276954.X

(51) Int. Cl. B06B 1/16; B25J 13/08

(52) U.S. Cl. CPC B06B 1/161; B25J 13/084; Y10S 901/46

(57) ABSTRACT

A robot includes a body, artificial skin wrapped around the body, and a number of vibrators and a controller positioned in the body. The artificial skin includes a plurality of carbon nanotube films corresponding to different locations of the body and configured to generate an electrical signal when an external pressure is applied to the artificial skin. The controller is configured to obtain the electrical signal and control at least one vibrator to vibrate.

### FIELD

The subject matter herein generally relates to robots, and more particularly, to a robot capable of vibrating based on pressure.

### BACKGROUND

Robots are increasingly being employed in tasks that are otherwise dangerous or tedious for humans. The ability of a robot can be increased when tactile sensors are incorporated into the robotics to enable the robot to “feel” objects and to generate corresponding feedback.

### BRIEF DESCRIPTION OF THE DRAWINGS

Implementations of the present technology will now be described, by way of example only, with reference to the attached figures.

FIG. 1 is a diagrammatic view of an embodiment of a robot according to the present disclosure.

FIG. 2 is a cross-sectional view taken along line II-II of FIG. 1.

FIG. 3 is diagrammatic view showing the carbon nanotube film included in the robot of FIG. 1 in an original state.

FIG. 4 is similar to FIG. 3, but showing the carbon nanotube film after being pressed.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series and the like.

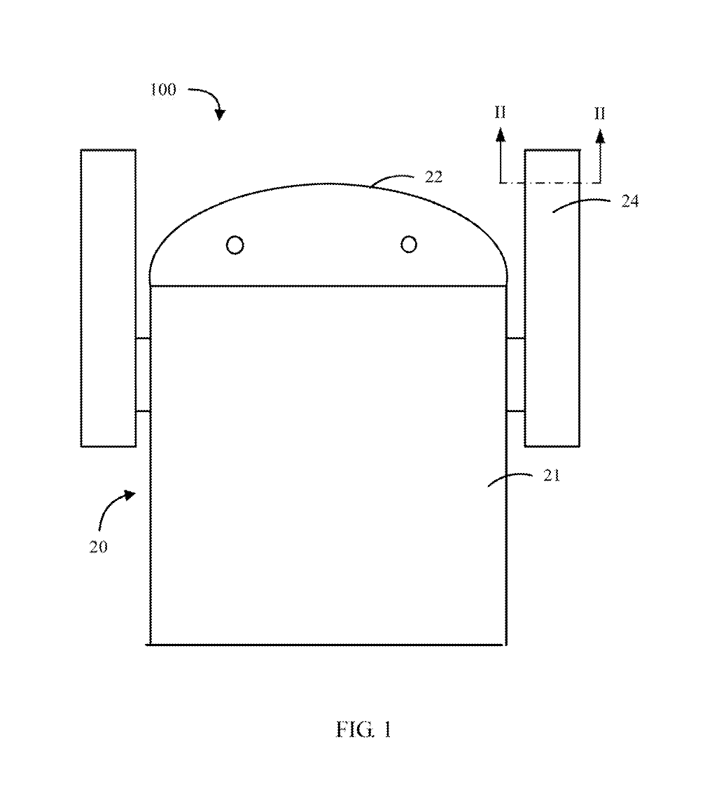

FIG. 1 illustrates an embodiment of a robot 100 including a body 20. The body 20 includes a main body 21, a head 22 secured to a top of the main body 21, and two robotic hands 24 secured to opposite sides of the main body 21.

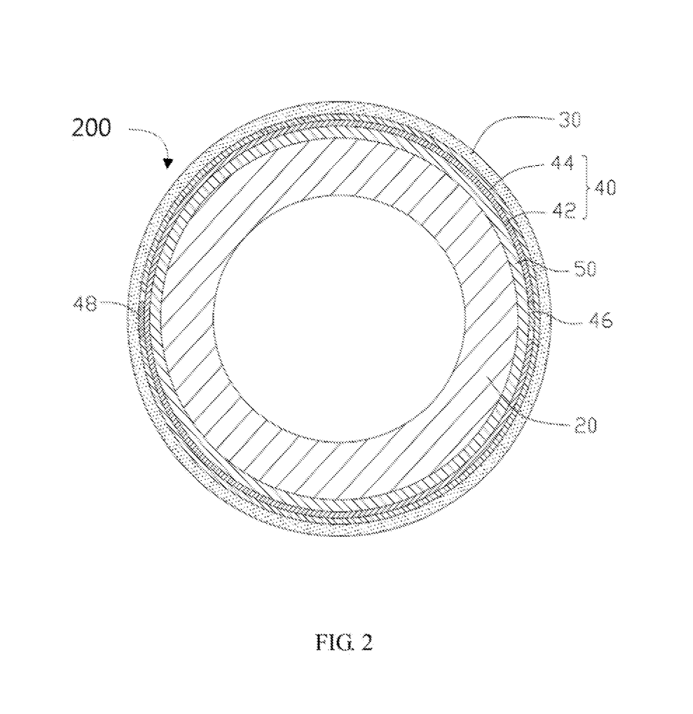

FIG. 2 illustrates that the robot 100 further includes an artificial skin 200 wrapped around the body 20 and configured to sense pressures applied to different locations on the body 20 (that is, the main body 21, the head 22, and the robotic hands 24). In at least one embodiment, the artificial skin 200 includes a number of substrates 50 wrapped around different locations of the body 20, respectively, a protection layer 30 wrapped around each substrate 50, and a carbon nanotube film 40 sandwiched between each substrate 50 and the corresponding protection layer 30. Each protection layer 30 can have a width and a length nearly identical to the width and the length of the corresponding substrate 50 and the corresponding carbon nanotube film 40. The substrates 50 can be separated and spaced from each other, and are wrapped around the body 20 besides some preset locations (for example, a wrist, an ankle, or a knee).

In another embodiment, the substrates 50 are connected to each other to form a continuous substrate. The protection layers 30 can also be connected to each other to form a continuous protection layer. The carbon nanotube films 40 are sandwiched between the substrate 50 and the protection layer 30, and correspond to different locations of the body 20.

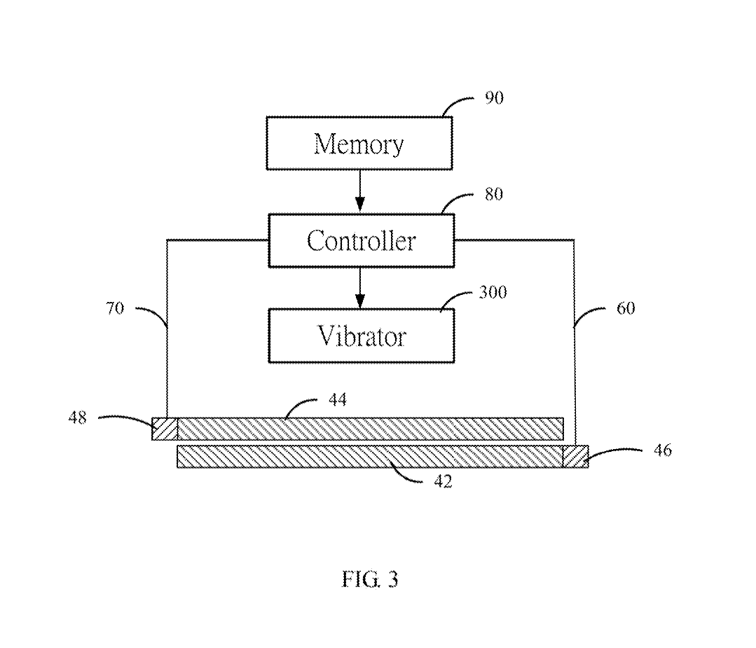

FIG. 3 illustrates that the robot 100 further includes a controller 80 and a number of vibrators 300 positioned in the body 20 (shown in FIG. 2). FIG. 3 only shows one vibrator 300 for simplicity. When an external pressure is applied to the artificial skin 200, the pressure will be delivered from one protection layer 30 to the corresponding carbon nanotube film 40. Then, the carbon nanotube film 40 generates an electrical signal in response to the pressure. The controller 80 obtains the electrical signal from the carbon nanotube film 40 and controls at least one vibrator 300 to vibrate, thereby causing the robot 100 to generate feedback in response to the pressure. In at least one embodiment, each vibrator 300 faces one protection layer 30. The controller 80 controls one vibrator 300 corresponding to the protection layer 30 being pressed to vibrate.

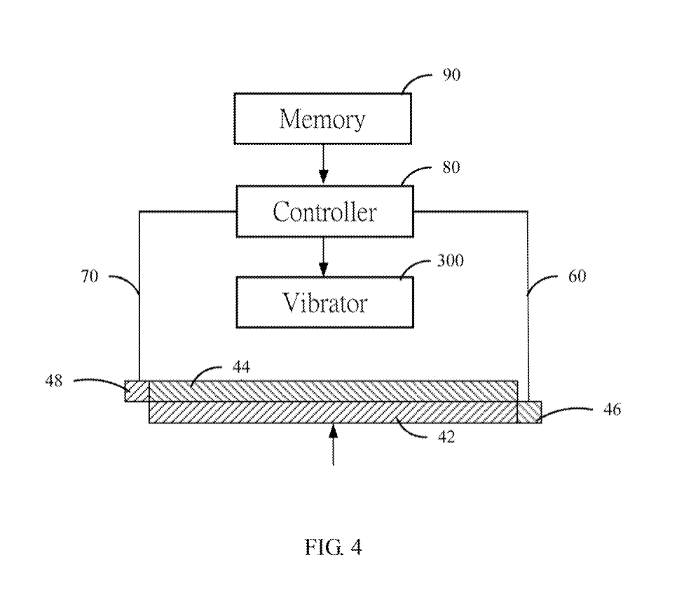

FIG. 3 further illustrates that each carbon nanotube film 40 includes a first carbon nanotube layer 42 and a second carbon nanotube layer 44 located above the first carbon nanotube layer 42. The second carbon nanotube layer 44 is spaced from the first carbon nanotube layer 42 in an original state. A first electrode 46 is connected to an end of the first carbon nanotube layer 42. A second electrode 48 is connected to an end away from the first electrode 46 of the second carbon nanotube layer 44. The first electrode 46 and the second electrode 48 are respectively connected to the controller 80 via a first wire 60 and a second wire 70. FIG. 4 illustrates that the first carbon nanotube film 42 and the second carbon nanotube film 44 are in contact with each other when the carbon nanotube film 40 is pressed, thereby causing the first electrode 46 and the second electrode 48 to be connected to each other to transmit the electrical signal to the controller 80.

In at least one embodiment, the carbon nanotube film 40 can generate a voltage signal in response to the pressure, and a value of the voltage signal is proportional to the pressure. The robot 100 further includes a memory 90 (shown in FIGS. 3-4) for storing a relationship between values of voltage signals and vibration data (such as amplitude or frequency of the vibration). Each vibration data corresponds to one value of the voltage signal. In at least one embodiment, the value of voltage signal is proportional to the vibration data. That is, the greater the pressure is, the greater the vibration data is (the vibration is stronger). The controller 80 determines a vibration data corresponding to the value of voltage signal according to the stored relationship and controls at least one vibrator 300 to vibrate with the determined vibration data.

In at least one embodiment, the first carbon nanotube film 42 and the second carbon nanotube film 44 can have a thickness of about 100 nm to about 500 nm. The first carbon nanotube film 42 and the second carbon nanotube film 44 can include single-wall carbon nanotube or multi-wall carbon nanotube. The first electrode 46 and the second electrode 48 can be made of a material selected from a group consisting of gold (Au), silver (Ag), platinum (Pt), aluminum (Al), nickel (Ni), copper (Cu), titanium (Ti), and selenium (Se). The substrate 50 is flexible, and can be made of rubber or silicon. The protection layer 30 is transparent, and can be made of a material selected from a group consisting of polyethylene terephthalate (PET), polystyrene (PS), polyethylene (PE), polycarbonate (PC), polymethyl methacrylate (PMMA), benzo-cyclo-butene (BCB), and polyolefin.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A robot comprising:
a body;
an artificial skin wrapped around the body and including a plurality of carbon nanotube films corresponding to different locations on the body, at least one of the plurality of carbon nanotube films configured to generate an electrical signal when an external pressure is applied to the artificial skin;
a plurality of vibrators positioned in the body; and
a controller positioned in the body and configured to obtain the electrical signal and to control at least one of the plurality of vibrators to vibrate.

2. The robot of claim 1, wherein each of the plurality of vibrators faces one of the plurality of carbon nanotube films; the controller is configured to control one of the plurality of vibrators corresponding to the carbon nanotube film being pressed to vibrate.

3. The robot of claim 1, wherein each of the plurality of carbon nanotube film comprises a first carbon nanotube layer and a second carbon nanotube layer located above the first carbon nanotube layer; the second carbon nanotube layer is spaced from the first carbon nanotube layer in an original state; a first electrode is connected to an end of the first carbon nanotube layer; a second electrode is connected to an end of the second carbon nanotube layer and away from the first electrode; the first electrode and the second electrode respectively connected to the controller; the first carbon nanotube film and the second carbon nanotube film are in contact with each other when the carbon nanotube film is pressed, thereby causing the first electrode and the second electrode to be connected to each other and transmit the electrical signal to the controller.

4. The robot of claim 3, wherein the first carbon nanotube film and the second carbon nanotube film have a thickness of about nm to about nm.

5. The robot of claim 3, wherein the first carbon nanotube film and the second carbon nanotube film comprises single-wall carbon nanotube or multi-wall carbon nanotube.

6. The robot of claim 3, wherein the first electrode and the second electrode are made of a material selected from a group consisting of gold, silver, platinum, aluminum, nickel, copper, titanium, and selenium.

7. The robot of claim 1, wherein the artificial skin further comprises a plurality of substrates wrapped around the different locations of the body and a protection layer wrapped around each of the plurality of substrate; each of the plurality of carbon nanotube films is sandwiched between one substrate and the corresponding protection layer; the pressure is delivered from one protection layer to the corresponding carbon nanotube film.

8. The robot of claim 7, wherein each of the plurality of substrates is made of rubber or silicon.

9. The robot of claim 7, wherein each of the plurality of protection layers is transparent, and is made of a material selected from a group consisting of polyethylene terephthalate, polystyrene, polyethylene, polycarbonate, polymethyl methacrylate, benzo-cyclo-butene, and poly olefin.

10. The robot of claim 1, wherein the artificial skin further comprises a substrate wrapped around the body and a protection layer wrapped around the substrate; each of the plurality of carbon nanotube films is sandwiched between the substrate and the protection layer; the pressure is delivered from the protection layer to one corresponding carbon nanotube film.

11. The robot of claim 1, wherein each of the plurality of carbon nanotube films is configured to generate a voltage signal in response to the pressure, and a value of the voltage signal being proportional to the pressure; the robot further comprises a memory for storing a relationship between values of voltage signals and vibration data, each vibration data corresponding to one value of the voltage signal; the controller is configured to determine a vibration data corresponding to a value of voltage signal according to the stored relationship and to control the at least one vibrator to vibrate with the determined vibration data.

12. The robot of claim 11, wherein the vibration data is an amplitude or a frequency of the vibration.

13. The robot of claim 11, wherein the value of voltage signal is proportional to the corresponding vibration data.
